(19) United States
(12) Patent Application Publication
(10) Pub. No.: US 2004/0007055 A1
(43) Pub. Date: Jan. 15, 2004

(54) Apparatus for accumulating and transferring lubricant of an internal combustion engine sump

(76) Inventors: John Paul Kralik, Hudson, OH (US); Todd Christopher Cronin, Fairview, OH (US); Rishi Raj Kothari, Wickliffe, OH (US); Andrew Raymond Spriegel, Willoughby Hills, OH (US); Christopher Alan Jethrow, Maple Heights, OH (US); Min She, Sagamore Hills, OH (US); Gary Lee Orloff, Mentor, OH (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/195,218

(22) Filed: Jul. 15, 2002

(51) Int. Cl. G01M 19/00

(52) U.S. Cl. 73/118.1

(57) ABSTRACT

An apparatus for remotely monitoring the level of lubricant in a sump of an internal combustion engine on a vehicle and remotely transferring lubricant from the engine sump including a lubricant tank mounted on the vehicle external to the vehicle's engine. The lubricant tank and the engine may each contain a quantity of gas above the respective lubricant levels in the tank and the sump with the pressure of gas contained in the lubricant tank being regulated relative to the pressure of gas contained in the engine such that the level of lubricant in the tank is indicative of and varies along with the level of lubricant in the engine sump. The apparatus may include an equalization connection between the sump and the tank and an evacuation connection to the tank for transferring lubricant from the tank. The tank may include a plurality of internal chambers situated for lubricant to flow between them to prevent lubricant from being drawn out of the sump below a lubricant low-level limit of the sump. The interior of the tank may include horizontally and vertically disposed baffles to reduce sloshing of lubricant in the tank.

### BACKGROUND OF INVENTION

This invention relates generally to the field of internal combustion engines, and more particularly to an apparatus for measuring the level of a lubricant in the sump of an internal combustion engine, accumulating a predetermined quantity of lubricant and subsequently transferring the quantity through a lubricating circuit.

Internal combustion engines are usually provided with systems for circulating oil or similar lubricants to moving components of the engine during operation. Such systems may include reservoirs or other containers for temporarily storing lubricant during the circulation process. The systems may also include various configurations of lubricating circuits that direct the flow of lubricant among the various system components.

The reliability of an internal combustion engine is directly affected by the condition and level of the lubricant used in the engine. Many internal combustion engines are relatively large such as those used by locomotives. Typically these engines include a sump formed as part of the crankcase within which lubricant is contained for supplying lubricant to moving components during operation of the engine. When an engine is installed on a locomotive the sump is frequently situated in a location that makes routine access to the sump difficult. This can make checking the lubricant level of the sump a difficult task. Further, when the engine is in operation the lubricant in the sump tends to move about or slosh due to vibration, movement of the locomotive and lubricant returning to the sump within a lubricating circuit. Such movement of the lubricant can make it difficult to accurately measure the lubricant level during operation of the engine. This in turn can make it difficult to determine whether the lubricant has fallen below the OEM low-level limit.

Internal combustion engines may include lubricating systems that transfer predetermined quantities of lubricant from one part of the system to another when certain conditions are satisfied. For example, the lubricating system of a locomotive may provide for the transfer of a portion of the lubricant to the fuel system when the condition of the lubricant satisfies a predetermined set of criteria. The lubricant may be pumped directly from the sump to the fuel system. Fresh lubricant may then be provided from a lubricant reservoir or other source to replace the lubricant transferred to the fuel system. Transferring lubricant in this manner can help maintain the lubricant quality above a minimum threshold, which may extend the operating interval between recommended lubricant changes.

The motion of lubricant in the sump can make transferring accurate quantities of lubricant difficult. This may be due to the location of an outlet orifice in the sump through which lubricant may be pumped to the fuel system. If an outlet orifice is situated at or near the lubricant's low-level limit in the sump then an undesirable quantity of air may be drawn through the orifice into the lubricating circuit in addition to the lubricant being transferred. This may result in less lubricant being transferred than was predicted, which may cause the system to perform less than optimally. The outlet orifice may be placed below the low-level limit to minimize or eliminate air getting into the circulating system. The disadvantage of this placement is that lubricant may inadvertently be removed out of the sump so that the lubricant is below the low-level limit. This may lead to undesirable consequences to the performance characteristics of the engine.

In view of the above, there is a need for an apparatus for conveniently and accurately checking the fluid level in the sump of an internal combustion engine during operation and shut down. There is a further need to ensure an accurate quantity of lubricant is transferred from the sump to other portions of a lubricating circuit, such as to the fuel system where the quantity of lubricant is combusted with the fuel.

### BRIEF DESCRIPTION OF THE INVENTION

In one aspect of the present invention, an apparatus is provided comprising a lubricant tank mounted on a vehicle external to the engine for containing a quantity of lubricant and a quantity of gas above a level of lubricant in the lubricant tank; an outlet port in the lubricant tank for removing lubricant from the lubricant tank; a first fluid conduit connecting the lubricant tank and the engine sump for flow of lubricant between the lubricant tank and the engine sump; the engine sump containing a quantity of lubricant and the engine containing a quantity of gas above a level of lubricant in the engine sump; and with a pressure of the quantity of gas contained in the lubricant tank being regulated relative to a pressure of the quantity of gas contained in the engine such that the level of lubricant in the lubricant tank is indicative of and varies along with the level of the lubricant in the engine sump.

One exemplary embodiment of the present invention allows for an equalizing connection for connecting the tank and the sump to regulate the respective pressures between the tank and the sump to allow the levels of lubricant in the tank and the sump to equalize. In one exemplary embodiment, the tank and the sump may be regulated by venting them to ambient pressure, which allows for the lubricant to “seek its own level” so that the high lubricant level in the sump will correspond with the high lubricant level in the tank. In an alternate embodiment, the equalizing connection may be a fluid connection to connect the tank to the sump at levels above the respective lubricant levels in the tank and the sump. In alternate embodiments, the tank and the sump may be maintained at the same or different relative pressures such that the pressure between them may be regulated to allow the levels of lubricant in the sump and the tank to equalize. In this respect, conventional pressure regulators may regulate the pressures in the tank and the sump.

The first fluid connection between the tank and the sump may be configured so that the lubricant low-level limit of the sump is the same level horizontally as a lubricant draw down limit of the tank. Equalizing the high levels of lubricant in the tank and the sump and setting a drawn down limit in the tank allows for defining a known quantity of lubricant in the tank. Setting the fluid connection on the sump no lower than the sump's low-level limit prevents lubricant from being drained from below the sump's low-level limit. The evacuation connection may be connected to an outlet port of the tank proximate the lubricant draw down limit so that only the known quantity of lubricant may be removed from the tank.

One exemplary embodiment of the present invention allows for a set of baffles to be provided in the tank to reduce the motion or sloshing of lubricant within the tank. This allows for an accurate amount of lubricant to accumulate within the tank that may subsequently be transferred to another portion of the lubricating circuit such as to the fuel system. It also allows for an accurate determination of the level of lubricant within the sump by determining the level of lubricant within the tank. A level sensor and/or dipstick may be used for determining the level of lubricant within the tank.

### BRIEF DESCRIPTION OF THE DRAWINGS

FIG. 1 is a schematic illustration of an exemplary lubricating circuit within which an embodiment of the present invention is incorporated;

FIG. 2 is a perspective view of one exemplary embodiment of a tank of the present invention;

FIG. 3 is a perspective view of a portion of the tank of FIG. 2;

FIG. 4 is a cross-sectional view taken along line 4-4 of FIG. 5;

FIG. 5 is and end view of the tank of FIG. 2;

FIG. 6 is a side view of the tank of FIG. 2;

FIG. 7 illustrates a cross-sectional view taken along line 7-7 of FIG. 6; and

FIG. 8 illustrates a perspective view of one exemplary embodiment of a tank of the present invention.

### DETAILED DESCRIPTION OF THE INVENTION

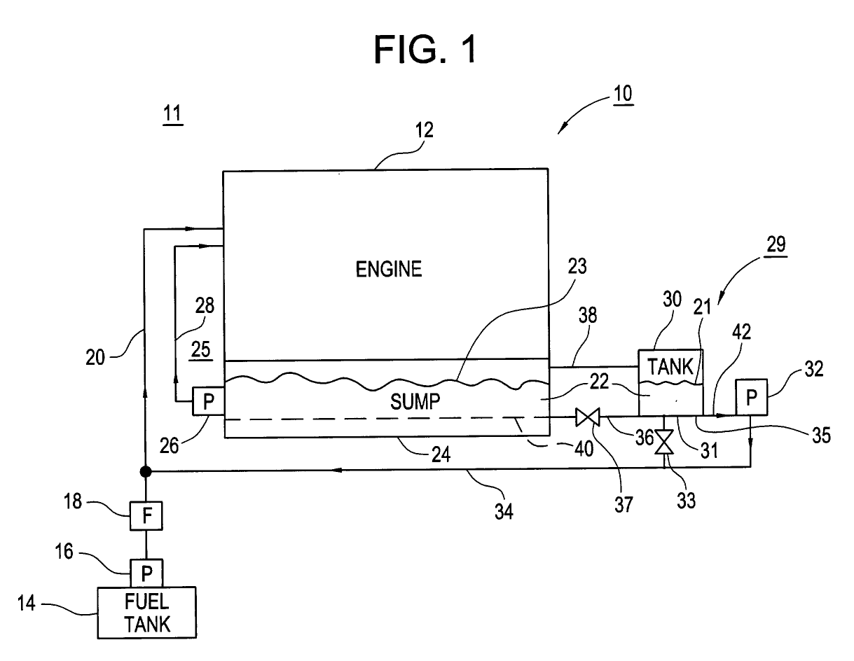

FIG. 1 is a schematic illustration of a selected system 10 from a vehicle 11 powered by an internal combustion engine 12. The vehicle 11 may be, for example, an automobile, heavy machinery or a locomotive. The engine 12 may be a gasoline or diesel engine, for example, or other types of engines yet to be designed. The engine 12 is supplied with fuel by a fuel supply circuit including a fuel tank 14, fuel pump 16, fuel filter 18 and fuel supply line 20. The moving parts of engine 12 are lubricated and cooled by a lubricant 22 such as oil or other hydrocarbon substances, synthetic lubricant, or a combination thereof. During operation of the engine 12, lubricant 22 may be continually pumped from the engine sump 24 by a lubricant circuit 25 including a lubricant pump 26 and lubricant supply line 28. The lubricant circuit 25 pumps lubricant 22 from the sump 24 to those areas of engine 12 requiring lubrication and/or cooling. During this process, lubricant 22 will collect in engine sump 24 after passing over moving components of engine 12. Engine sump 24 may typically be a crankcase oil pan attached to engine 12.

An apparatus 29 for accumulating and subsequently transferring lubricant 22 may include a tank 30 mounted to the vehicle 11 external to and in fixed relation to the engine 12. Tank 30 may be in fluid communication with the engine sump 24 and fuel supply line 20. A pump 32 may be provided to pump lubricant 22 from the tank 30 and direct it to the fuel supply line 20 through a supply line 34. Tank 30 may be in fluid communication with engine sump 24 by means of a first fluid connection or conduit 36 and an equalizing or fluid conduit connection 38. Connections 36 and 38 may be conventional hoses made of plastic or rubber, for example, or they may be constructed of other suitable materials. Fluid connection 36 may be connected at one end to the engine sump 24 proximate a lubricant low-level limit 40. In one exemplary embodiment, this end of the connection 36 is no lower than or slightly above the low-level limit 40 to ensure that lubricant 22 does not drain out of sump 24 below the limit 40. In alternate embodiments, this end of connection 36 may be below the low level limit 40. The opposite end of fluid connection 36 may be connected to the tank 30 proximate a lubricant draw down limit 35 of the tank 30. The lubricant draw down limit 35 is a level within tank 30 below which lubricant 22 will not be drawn when removed from the tank 30. This is important for defining a predetermined or known amount of lubricant 22, which may be removed from the tank 30. For example, as shown in FIG. 1, the bottom 31 of tank 30 may define the lubricant draw down limit 35. A predetermined or known quantity of lubricant 22 would then be defined by the total volume of lubricant 22 in tank 30 once the levels of lubricant 22 in the sump 24 and the tank 30 have equalized. One exemplary embodiment allows for the bottom 31 of tank 30 to be positioned on a platform of the vehicle 11, for example, so that the bottom 31 of tank 30 is horizontally level with the low-level limit 40 of the sump 24. In alternate embodiments, the bottom 31 may be below the low-level limit 40 of sump 24 provided that a predetermined or known quantity of lubricant 22 may be removed from tank 30 without allowing lubricant 22 in the sump 24 to fall an unacceptable amount below the sump's low-level limit 40.

One aspect of the present invention allows for the levels of lubricant 22 in the sump 24 and the tank 30 to equalize. In one exemplary embodiment, the equalizing connection 38 may be provided so that one end connects with the engine sump 24 at a point above the upper surface 23 of the lubricant 22. The equalizing connection 38 may be a conventional hose made of rubber or plastic, for example, or it may be constructed of other suitable materials. The opposite end of equalizing connection 38 may be connected to the tank 30. This arrangement allows for the ambient pressure between the engine sump 24 and the tank 30 to equalize. In alternate embodiments, the sump 24 and tank 30 may be subject to equal pressure, such as atmospheric pressure. When the pressure is equalized between the sump 24 and the tank 30 lubricant 22 will “seek its own level” by operation of gravity and cause a quantity of lubricant 22 to pass through the fluid connection 36 and accumulate in tank 30 after sump 24 is filled to its normal operating capacity. Consequently, the level of lubricant 22 in engine sump 24 and tank 30 will equalize so that the high level 21 in tank 30 is substantially level with, or corresponds to, the high level 23 in the engine sump 24.

In one exemplary embodiment, the engine sump 24 may be that of a locomotive, which may have a capacity of approximately 400 gallons of lubricant 22. After an engine sump 22 having this approximate capacity is filled, such as during a standard maintenance period, it may take up to about 45 minutes for the lubricant 22 in tank 30 to achieve the same high level as that of the lubricant 22 in engine sump 24. In an alternate embodiment, pump 32 or a separate pump (not shown) may be aligned to transfer lubricant 22 from the engine sump 24 to the tank 30 to decrease the amount of time it takes for the levels of lubricant 22 to equalize between tank 30 and the engine sump 24. Similarly, the diameter of equalizing connection 38 and fluid connection 36 may vary as a function of system design and performance specifications, which may also vary the amount of time it takes to equalize the levels of lubricant 22 between the engine sump 24 and the tank 30.

In one exemplary embodiment tank 30 may be in fluid communication with fuel supply line 20 by means of an evacuation connection 42 and supply line 34. Evacuation connection 42 may include an outlet port and be connected to tank 30 to define the level within tank 30 that constitutes the lubricant draw down limit of tank 30. As shown in FIG. 1, the evacuation connection 42 is connected proximate the bottom 31 of tank 30 so that the draw down limit is established at 35. In alternate embodiments the evacuation connection 42 may be connected to other portions of tank 30, as more fully described below. As shown in FIG. 1, the elevational position of the bottom 31 of tank 30 may be horizontally level with the low-level limit 40 of the sump 24. In alternate embodiments, the bottom 31 of tank 30 may be below or above the low-level limit 40 of sump 24 provided that the fluid connection 36 and evacuation connection 42 are configured to evacuate or remove a quantity of lubricant from tank 30 and prevent lubricant 22 from being drawn or drained below the low-level limit 40. It will be recognized by those skilled in the art that various configurations are feasible. These embodiments provide an important safety feature by avoiding the potentially adverse consequences to engine 12 of permitting the lubricant level in the engine sump 24 to be drawn down or drained appreciably below the lubricant low-level limit 40. It will be appreciated by those skilled in the art that the lubricant 22 may fall slightly below the low-level limit 40 of the sump 24 provided that the amount the lubricant 22 falls below the low-level limit 40 is within the tolerances of the manufacturer's specifications for avoiding adverse consequences to the engine 12.

In one exemplary embodiment, the pump 32, which may be a conventional pump known in the art, may evacuate a predetermined quantity of lubricant 22 from tank 30 at predetermined intervals. For example, if the condition of lubricant 22 falls below a predetermined threshold then a control system of vehicle 11 may activate pump 32 to evacuate the predetermined quantity of lubricant 22 from tank 30. The removed lubricant may be directed to the fuel supply line 20, for example, so that the lubricant may be combusted with fuel in engine 12. Alternatively, the removed lubricant may be directed to a vehicle's 11 lubricating circuit 25, waste reservoir, etc. as a function of design and operational parameters of engine 12 or other onboard vehicle 11 systems. The removed lubricant may then be replaced from an on board lubricant reservoir (not shown), from an off board supply reservoir or other similar sources during a subsequent maintenance period. The rate that lubricant 22 is removed from the tank 30 may be significantly greater than the rate that the sump 24 and tank 30 equalize to assure that the predetermined quantity of lubricant 22 is removed from the tank 30 before additional lubricant 22 begins to accumulate in tank 30 through the fluid connection 36. In one exemplary embodiment a conventional valve 37 may be provided that may be closed during evacuation to prevent the flow of lubricant 22 from the sump 24 to the tank 30. In another exemplary embodiment, the pump 32 may pump at a sufficiently high rate, such as a rate of approximately one (1) liter per minute for example, to evacuate the lubricant 22 from the tank 30. This rate allows the predetermined or known quantity of lubricant 22 in tank 30 to be completely or almost completely removed prior to an appreciable amount of lubricant 22 beginning to accumulate in tank 30 through the fluid connection 36. Evacuating a predetermined or known quantity of lubricant is advantageous because it allows for an accurate accounting of lubricant in the vehicle's 11 system. This is important for maintaining the condition of lubricant through regeneration and/or replacement procedures.

In an alternate embodiment, lubricant 22 may be gravitationally removed from tank 30 through a valve 33 that may be operated by electrical, hydraulic, pneumatic, or mechanical means or by a combination of these means. A control system of the vehicle 11 may operate valve 33. The valve 33 may be a conventional valve and in one exemplary embodiment may include an interlock that would fail in the closed position only. For example, valve 33 may include a piston for in taking a predetermined or known quantity of lubricant 22 from tank 30 and a piston for exhausting that quantity into the supply line 34. An alternate valve 33 may include an inlet port and an outlet port that meter a predetermined or known quantity of lubricant 22 from the tank 30 and direct it into the supply line 34, for example. The valve 33 may be positioned immediately below the tank 30 and may be selectively controlled for whatever amount of time is necessary to meter the predetermined quantity of lubricant 22 out of the tank 30. Alternatively, the valve 33 may be positioned elsewhere on the vehicle 11, such as beneath the engine 12 for example, provided that lubricant 22 may gravitationally flow from the tank 30 to the valve 33. The volume of lubricant 22 metered by valve 33 during each cycle of the valve may be less than the total volume of lubricant 22 accumulated in tank 30. This allows for a predetermined or known quantity of lubricant 22 to be metered from tank 30 over time rather than evacuating it at a rapid rate or in its entirety in one cycle. For example, valve 33 may have a capacity of 100 milliliters for each cycle so that it would take 10 cycles to remove one liter of lubricant 22 from the tank 30. In this respect, as lubricant 22 is metered out of tank 30, the equalization of sump 24 and tank 30 will allow additional lubricant 22 to flow into tank 30 through fluid connection 36. This may allow for a relatively constant amount of lubricant 22 to be maintained in tank 30. In one exemplary embodiment, the rate at which lubricant 22 is metered from tank 30 may be substantially the same as the rate at which replacement lubricant 22 flows into tank 30 due to the equalization of sump 24 and tank 30. In alternate embodiments these rates may vary.

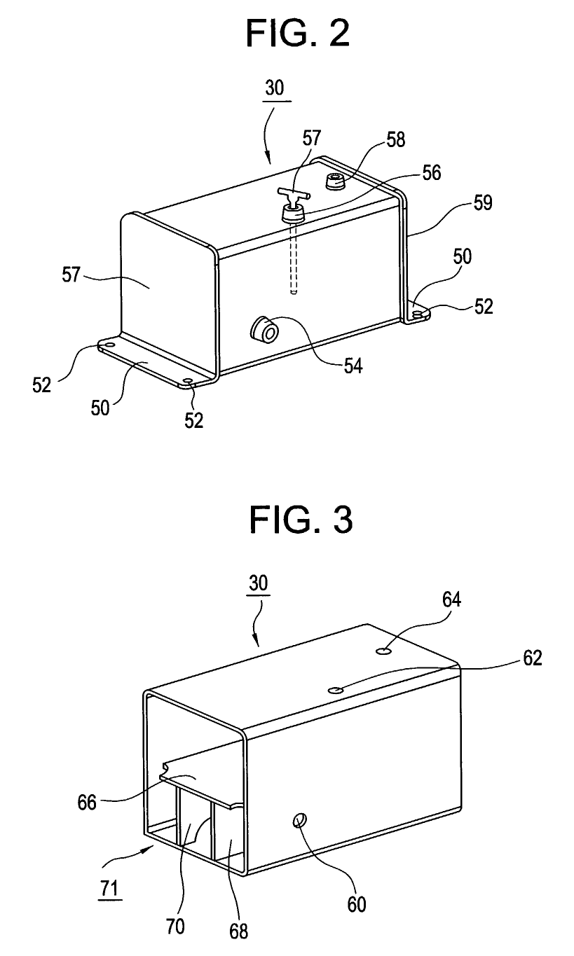

FIG. 2 illustrates a perspective view of one exemplary embodiment of tank 30. Tank 30 may be constructed of conventional materials such as steel, plastic or any other material that can provide sufficient structural integrity. In one exemplary embodiment tank 30 has a lubricant 22 capacity of about 1 to 2 liters. Tank 30 may vary in its shape and capacity as a function of design and performance specifications as will be recognized by those skilled in the art. Tank 30 may be provided with end brackets 50 having apertures 52 formed therein for mounting tank 30 to a platform on vehicle 11 such as a locomotive, for example. Tank 30 may be mounted on such a platform external to the locomotive's engine. Alternate embodiments may include other means for mounting tank 30 so that it is mounted in fixed relation to the engine sump 24. Fittings 54, 56 and 58 may be provided to fit over respective apertures 60, 62 and 64 shown in FIG. 3. Fittings 54, 56 and 58 may be of a conventional threaded type such as boss, thredolet or other appropriate fittings known in the art. Fitting 54 may be adapted to connect one end of the evacuation connection 42 to tank 30. Fitting 56 may be adapted to receive a conventional dipstick 57 for determining the level of lubricant 22 in tank 30. Providing dipstick 57 is advantageous because the level of lubricant 22 may be checked visually with dipstick 57 when the engine 12 is operating. Fitting 58 may be adapted to connect one end of the equalizing connection 38 to the tank 30 for allowing the ambient pressure between the tank 30 and the engine sump 24 to equalize.

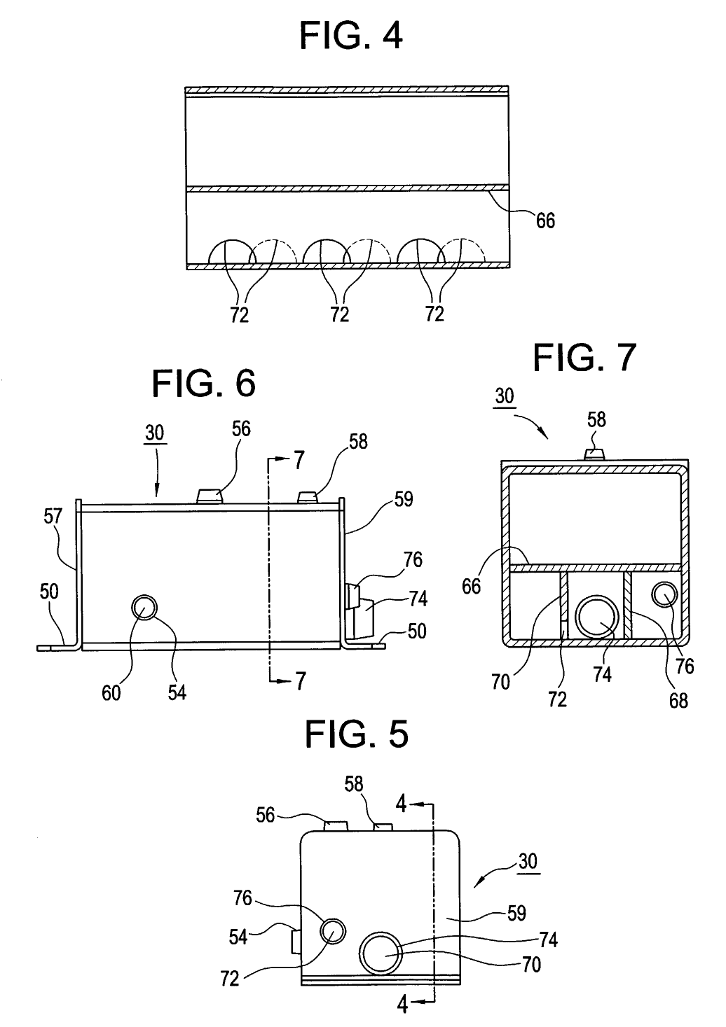

FIG. 3 illustrates an exemplary embodiment of tank 30 with the ends 57 and 59 broken away. The interior of tank 30 may include a substantially horizontal interior plate 66, a first substantially vertical partition 68 and a second substantially vertical partition 70. The first partition 68 and the second partition 70 may be disposed below the plate 66. Partitions 68 and 70 may each include a plurality of cutouts 72, as best shown in FIG. 4, disposed along their longitudinal axis. In one exemplary embodiment, each partition 68 and 70 may include three cutouts 72 each formed as a semi-circle. Partitions 68 and 70 may be disposed within tank 30 so that the cutouts 72 of one partition 68 or 70 are staggered or horizontally offset relative to the cutouts 72 of the other partition 68 or 70, as best shown in FIG. 4. Staggering or horizontally offsetting cutouts 72 improves the ability of the baffle arrangement 71 to minimize sloshing of lubricant 22 within tank 30. As will be recognized by those skilled in the art, alternate embodiments of the baffle arrangement 71 may include only one vertical partition or a plurality of vertical partitions as a function of the size of tank 30. Similarly, the number and shape of cutouts 72 may vary as a function of the size of tank 30 and other design and performance parameters. FIG. 5 shows end 59 of tank 30, which may include apertures 70 and 72. Respective fittings 74 and 76 may be provided for apertures 70 and 72. Fitting 74 may be adapted to connect one end of the evacuation connection 42 to tank 30. The other end of the evacuation connection 42 may be in fluid connection with fuel supply line 20 so the lubricant 22 removed from tank 30 may be combusted with the fuel, for example. The removed lubricant may be directed to other portions of a vehicle's 11 lubricating circuit such as a filter for removing contaminants from lubricant 22 before returning lubricant 22 to the engine sump 24 or to a storage container for later disposal.

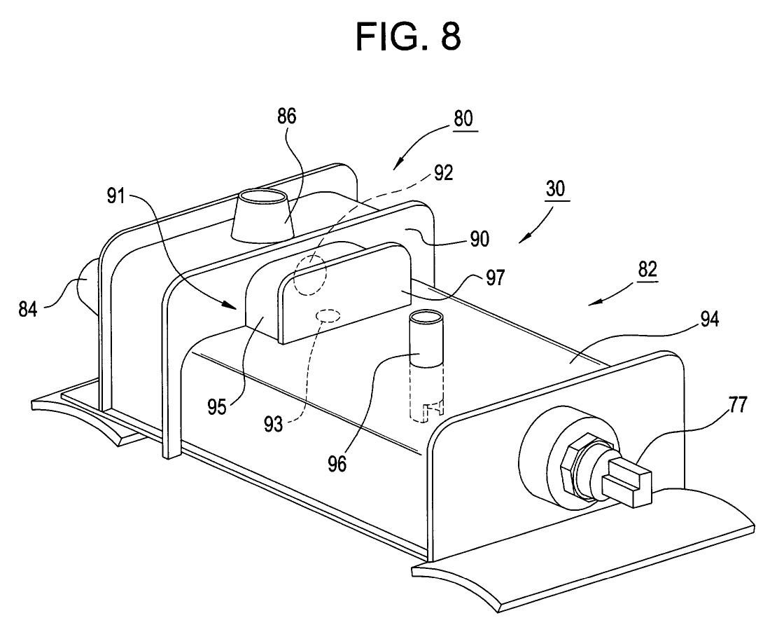

FIG. 6 illustrates a side view of an exemplary embodiment of the tank 30 and FIG. 7 illustrates an end view of the embodiment of FIG. 6. Fitting 76 may be provided to receive a conventional level sensor 77, shown in the exemplary embodiment of FIG. 8, that operate on the principle of capacitance measurement for measuring the level of lubricant 22 in tank 30. Alternate embodiments may include other appropriate sensors such as float sensors, infrared, ultrasonic, optic, radiation detection and frequency of vibration sensors, for example, for measuring the level of lubricant 22 in tank 30. The level sensor 77 may be in contact with the lubricant 22 and may provide continuous or discrete output signals indicative of the level of lubricant 22 in tank 30. The elevational relationship and fluid connections of tank 30 and engine sump 24 as shown in FIG. 1 allows for the level of lubricant 22 in tank 30 to correspond to the lubricant 22 level in engine sump 24. This arrangement is advantageous in that the level of lubricant 22 in the engine sump 24 can be easily checked by the level sensor 77 and/or by use of the dipstick 57 removably disposed in aperture 62 and fitting 57.

FIG. 8 illustrates another exemplary embodiment of tank 30. Tank 30 may be a multi-chamber tank that in one exemplary embodiment includes a first lubricant chamber generally referred to as 80 and a second lubricant chamber generally referred to as 82. It will be recognized by those skilled in the art that other exemplary embodiments of tank 30 may include more than two chambers. Second chamber 82 may be fabricated to a predetermined size and in one exemplary embodiment has a volume of between about one (1) and two (2) liters. A conventional fitting or boss 84 may be provided to connect the first chamber 80 with the sump 24 via the fluid connection 36. In one exemplary embodiment, a conventional fitting or boss 86 may be provided for receiving one end of the equalization connection 38 to connect the tank 30 to the sump 24 for equalizing the level of lubricant in sump 24 and the first chamber 80. First chamber 80 and second chamber 82 may be separated by a solid partition 90.

A second fluid connection generally referred to as 91 in FIG. 8 may be provided that includes a first aperture 92 formed in partition 90 and a second aperture 93 formed in the top 94 of the second chamber 82. In one exemplary embodiment aperture 92 may be larger than aperture 93 to regulate the flow of lubricant 22 into the second chamber 82. For example, aperture 92 may be generally about one (1) inch in diameter and aperture 93 may be generally about one-half (½) in diameter. Alternate embodiments may size these apertures differently depending on design and performance specifications of the tank 30. Fluid connection 91 may be encased by a hood 95 and front panel 97 as shown in FIG. 8 to keep lubricant 22 contained as it passes from the first chamber 80 to the second chamber 82. The hood 95 may be connected to and extend from the partition 90 and rest on the top 94 of the second fluid chamber 82 in a sealed arrangement. The front panel 97 may be attached to the hood 95 with both sealed together and to the top 94 of the second chamber 82 to prevent lubricant 22 from leaking while being transferred from the first chamber 82 to the second chamber 84. Sizing aperture 93 to be smaller than aperture 92 allows for a quantity of lubricant 22 to pool in the chamber formed by the hood 95, front panel 97, partition 90 and the portion of the top 94 under the hood 95. The lubricant 22 pooled in this chamber may then flow into the second chamber 82 in a substantially steady flow through aperture 93. With this arrangement, the lubricant 22 flows out of chamber 80 at a faster rate than in flows into chamber 82. This effect minimizes sloshing of lubricant 22 in the chamber 82 and makes determining the level of lubricant 22 in the chamber 82 more accurate. This in turn allows for predetermined or known quantities of lubricant 22 to be selectively removed from the second chamber 82.

Fluid connection 91 allows lubricant 22 to cascade or spill over under the force of gravity from a higher or first level in chamber 80 into a lower or second level in chamber 82. This cascading or spilling effect allows lubricant 22 to “seek its own level” by falling like a waterfall from the first chamber 80 to the second chamber 82 as the level of lubricant 22 in the first chamber 80 rises. In alternate embodiments, fluid connection 91 may include a cylindrical or graduated hose that connects aperture 92 with aperture 93, for example, which may eliminate the hood 95 and front panel 97. Those skilled in the art will recognize that alternate means may be employed for providing the fluid connection 91 between the first chamber 80 and the second chamber 82.

As the first chamber 80 fills with lubricant 22 flowing from sump 24 through the fluid connection 36 into the tank 30, the level of lubricant 22 in the first chamber 80 will rise toward the lower apex of aperture 92. When the lubricant 22 reaches this level of aperture 92 the lubricant 22 may begin to cascade or fall through aperture 92 onto a portion of the top 94 of the second chamber 82 and through aperture 93 formed the top 94. In one exemplary embodiment, the lower apex of aperture 92 is positioned so that it is substantially level with the lubricant low-level limit 40 of sump 24. Positioning aperture 92 at this level is advantageous because it prevents lubricant 22 from spilling through aperture 92 into the second chamber 82 when lubricant 22 is below the low-level limit 40 of sump 24. Consequently, lubricant 22 will not be pumped, drained or otherwise removed from the chamber 82 if lubricant 22 is below the low-level limit 40 of the sump 24.

As further shown in FIG. 8, the tank 30 may include a level sensor 77 positioned to detect the level of lubricant 22 contained in the second chamber 82. Alternate embodiments may include a level sensor for detecting the level of lubricant 22 in the first chamber 80. The level of the lubricant 22 in the first chamber 80 will correspond to the level of lubricant 22 in the sump 24 after the levels have equalized. An evacuation tube 96 may be provided for evacuating lubricant 22 from the second chamber 82. The evacuation tube 96 may extend into the second chamber 82 through any one of the walls or top 94 of chamber 82, for example, and may consequently draw lubricant 22 from the sides, top or bottom of the chamber 82. When chamber 82 has a sufficient amount of lubricant 22 contained therein then pump 32 may evacuate that volume of lubricant 22 from chamber 82 through the evacuation connection 42. Pump 32 may be provided with a sufficiently high power to draw lubricant 22 from chamber 82 at a relatively high rate, such as about one liter (1) per minute for example, regardless of the position of the evacuation tube 96. In alternate embodiments, the lubricant 22 may be metered from the second chamber 82 at varying rates by valve 33, for example, appropriately connected to tank 30.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

We claim:

1. An apparatus for remotely monitoring the level of lubricant in a sump of an internal combustion engine on a vehicle and remotely transferring lubricant from the engine sump, the apparatus comprising:
a lubricant tank mounted on a vehicle external to the engine for containing a quantity of lubricant and a quantity of gas above a level of lubricant in the lubricant tank;
an outlet port in the lubricant tank for removing lubricant from the lubricant tank;
a first fluid conduit connecting the lubricant tank and the engine sump for flow of lubricant between the lubricant tank and the engine sump;
the engine sump containing a quantity of lubricant and the engine containing a quantity of gas above a level of lubricant in the engine sump; and
with a pressure of the quantity of gas contained in the lubricant tank being regulated relative to a pressure of the quantity of gas contained in the engine such that the level of lubricant in the lubricant tank is indicative of and varies along with the level of the lubricant in the engine sump.

2. The apparatus of claim 1 further comprising:
an equalizing connection connecting the lubricant tank and the engine at points above their respective lubricant levels for regulating the gas pressure between the lubricant tank and the engine.

3. The apparatus of claim 1, the lubricant tank further comprising a draw down limit, the drawn down limit being no lower than a lubricant low-level limit of the engine sump to prevent lubricant within the engine sump from being drawn below the lubricant low-level limit of the engine sump when a quantity of lubricant is removed from the lubricant tank.

4. The apparatus of claim 1 further comprising a valve in fluid communication with the outlet port for allowing a quantity of lubricant to be removed from the lubricant tank under the force of gravity.

5. The apparatus of claim 1 further comprising a pump in fluid communication with the outlet port for removing a quantity of lubricant from the lubricant tank.

6. The apparatus of claim 5 wherein the quantity of lubricant is removed to at least one of a lubricating circuit and a fuel circuit.

7. The apparatus of claim 1 further comprising a level sensor disposed within the lubricant tank for detecting a level of the lubricant in the lubricant tank that corresponds to a level of the lubricant in the engine sump.

8. The apparatus of claim 7 wherein the level sensor is a capacitance sensor.

9. The apparatus of claim 1 further comprising:
a dipstick disposed within the lubricant tank for detecting a level of the lubricant within the lubricant tank that corresponds to a level of the lubricant in the engine sump.

10. The apparatus of claim 1 further comprising:
a baffle arrangement in the lubricant tank disposed at a lower end of the lubricant tank for stabilizing the level of lubricant therein against sloshing of the lubricant caused by vibration and movement of the lubricant tank.

11. The apparatus of claim 10, the baffle arrangement comprising at least one cutout disposed in a first vertical partition that is horizontally offset from at least one cutout disposed in a second vertical partition spaced from the first partition.

12. The apparatus of claim 1 where the engine and the lubricant tank are vented to atmospheric pressure to regulate the pressure of the quantity of gas contained in the lubricant tank relative to the pressure of the quantity of gas contained in the engine.

13. The apparatus of claim 1 further comprising:
a substantially horizontal plate disposed within the lubricant tank;
a first substantially vertical partition extending downwardly from the plate, the first vertical partition including a first plurality of cutouts along its longitudinal axis, each of the first plurality of cutouts being semicircular; and
a second substantially vertical partition extending downwardly from the plate and spaced apart from the first vertical partition, the second vertical partition including a second plurality of cutouts along its longitudinal axis, each of the second plurality of cutouts being semicircular, the first plurality of cutouts being horizontally offset from the second plurality of cutouts.

14. The apparatus of claim 1 wherein the lubricant tank further comprises:
a first chamber for receiving lubricant from the engine sump through the first fluid conduit;
a second chamber for receiving lubricant from the first chamber; and
a second fluid connection connecting the first chamber and the second chamber to allow lubricant to flow from the first chamber to the second chamber.

15. The apparatus of claim 14 wherein at least a portion of a volume of the second chamber is disposed below a lubricant low-level limit of the engine sump.

16. The apparatus of claim 14, the second fluid connection comprising a first aperture formed within the lubricant tank, the first aperture being substantially level with a lubricant low-level limit of the engine sump so that lubricant will not flow through the second fluid connection when a level of lubricant in the engine sump is below the low-level limit of the engine sump.

17. The apparatus of claim 14 further comprising:
a partition separating the first chamber and the second chamber; and
the second fluid connection comprising a first aperture formed in the partition.

18. The apparatus of claim 17, the second fluid connection further comprising:
a second aperture formed in a top portion of the second chamber, the second aperture being sized smaller than the first aperture; and
wherein the first aperture is formed in the partition above the second chamber to permit lubricant to cascade from the first chamber under the force of gravity as lubricant rises in the first chamber.

19. The apparatus of claim 14 wherein the evacuation connection is connected to the second chamber for transferring lubricant from the lubricant tank.

20. The apparatus of claim 19 wherein the lubricant is transferred from the second chamber to at least one of a lubricating circuit and a fuel circuit.

21. The apparatus of claim 19 further comprising a pump for transferring the lubricant from the second chamber.

22. The apparatus of claim 14 wherein the first fluid conduit connecting the lubricant tank and the engine sump is connected to the engine sump at a level proximate a lubricant low-level limit of the engine sump.

23. The apparatus of claim 14 further comprising a level sensor for determining a level of lubricant in the lubricant tank.

24. A vehicle comprising:
an engine comprising a lubricant circuit including a sump, the sump containing a quantity of lubricant and the engine containing a quantity of gas above a level of lubricant in the sump;
a tank mounted on the vehicle external to the engine for containing a quantity of lubricant and a quantity of gas above a level of the lubricant in the tank;
a first fluid conduit connecting the tank and the sump for allowing lubricant to flow there between;
an outlet port in the tank for removing lubricant from the tank; and
with a pressure of the quantity of gas in the tank being regulated relative to a pressure of the quantity of gas in the engine such that a the level of lubricant in the tank is indicative of and varies along the with level of lubricant in the sump.

25. The vehicle of claim 24 where the tank and the sump are vented to atmospheric pressure to regulate the pressure of the quantity of gas in the tank relative to the pressure of the quantity of gas in the engine.

26. The vehicle of claim 25 further comprising an equalizing connection connecting the tank and the engine at points above their respective lubricant levels for regulating the gas pressure between the tank and the engine.

27. A method for controlling the amount of lubricant transferred from a lubricating circuit of an internal combustion engine, the method comprising:
providing a tank external to a sump of the internal combustion engine;
transferring a quantity of lubricant from the sump to the tank to equalize a level of lubricant in the tank with a level of lubricant in the sump; and
removing a quantity of lubricant from the tank.

28. The method of claim 27 further comprising:
affixing a set of baffles inside of the tank to reduce sloshing of lubricant within the tank.

29. The method of claim 27 further comprising:
establishing a set of conditions for evacuating at least a portion of the quantity of lubricant from the tank; and
removing the at least a portion of the quantity of lubricant from the tank when the set of conditions are met.

30. The method of claim 29, the set of conditions comprising a measure of quality of the lubricant.

31. The method of claim 29, the step of removing comprising removing the quantity of lubricant from the tank to at least one of a lubricating circuit and a fuel circuit.
